(19) United States
(12) Patent Application Publication
(10) Pub. No.: US 2011/0109493 A1
(43) Pub. Date: May 12, 2011

(54) CONTROL DEVICE AND METHOD UTILIZING THE SAME

(76) Inventors: Jian-Ji CHEN, Taoyuan County (TW); Hong Lun Liu, Hualien County (TW)

(21) Appl. No.: 12/771,604

(22) Filed: Apr. 30, 2010

(30) Foreign Application Priority Data
Nov. 9, 2009 (TW) 98137890

(51) Int. Cl. G01S 13/00; G01S 15/00; G01C 3/08

(52) U.S. Cl. 342/91; 367/97; 356/4.01

(57) ABSTRACT

A control device including a signal emitter, a signal receiver, and a processing unit is disclosed. The signal emitter emits an output signal including a first output component and a second output component. The signal receiver receives an input signal. The input signal includes a reflected component when the first output component is reflected by an object. The input signal includes an emitted component when the second output component is received by the signal receiver. The processing unit compares a first threshold value with the amplitude of the input signal and compares a second threshold value with the amplitude of the input signal when the input signal simultaneously includes the reflected component and the emitted component. The processing unit differentiates the reflected component and the emitted component and invalidates the emitted component according to the compared results.

### CROSS REFERENCE TO RELATED APPLICATIONS

This application claims priority of Taiwan Patent Application No. 098137890, filed on Nov. 9, 2009, the entirety of which is incorporated by reference herein.

### BACKGROUND OF THE INVENTION

1. Field of the Invention

The invention relates to a control device, and more particularly to a control device comprising a signal emitter and a signal receiver.

2. Description of the Related Art

In a general wireless system, an emitter is utilized to emit a wireless signal. When the wireless signal encounters an object, the object reflects the wireless signal. The reflected wireless signal is referred to as a reflected signal. The wireless system utilizes a receiver to receive the reflected signal. However, the wireless signal emitted by the emitter may directly enter the receiver when the emitter closes the receiver. Since the conventional wireless system utilizes a fixed threshold value to determine whether the received signal is a reflected signal, a non-reflected signal (e.g. the wireless signal emitted by the emitter) may erroneously appear as serve the reflected signal.

To solve the described problem, a conventional method increases the threshold value to avoid having the non-reflected signal appear as the reflected signal. However, the conventional method cannot receive a weak reflected signal. Thus, the sensitivity of the wireless system is reduced,

Another conventional method reduces the threshold value. Although the sensitivity of the wireless system is increased, a non-reflected signal or noise signal may appear to be the reflected signal.

### BRIEF SUMMARY OF THE INVENTION

Control devices are provided. An exemplary embodiment of a control device comprises a signal emitter, a signal receiver, and a processing unit. The signal emitter emits an output signal comprising a first output component and a second output component. The signal receiver receives an input signal. The input signal comprises a reflected component when the first output component is reflected by an object. The input signal comprises an emitted component when the second output component is received by the signal receiver. The processing unit compares a first threshold value with the amplitude of the input signal and compares a second threshold value with the amplitude of the input signal when the input signal simultaneously comprises the reflected component and the emitted component. The processing unit differentiates the reflected component and the emitted component and invalidates the emitted component according to the comparing results.

A control method is provided. An exemplary embodiment of a control method is described in the following. An output signal is emitted. The output signal comprises a first output component and a second output component. An input signal is received. The input signal comprises a reflected component when the first output component is reflected by an object. The input signal comprises an emitted component when the second output component is directly received. When the input signal simultaneously comprises the reflected component and the emitted component, a first threshold value is compared with the input signal and a second threshold value is compared with the input signal to differentiate the reflected component and the emitted component and invalidate the emitted component.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of an operation system of the invention;

FIG. 2 is a schematic diagram of an exemplary embodiment of an input signal;

FIG. 3 is a schematic diagram of an exemplary embodiment of defining threshold values;

FIG. 4 is a timing diagram of an exemplary embodiment of the invention;

FIG. 5 is a flowchart of an exemplary embodiment of a control method of the invention; and

FIG. 6 is a flowchart of an exemplary embodiment of defining the first and the second threshold values.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

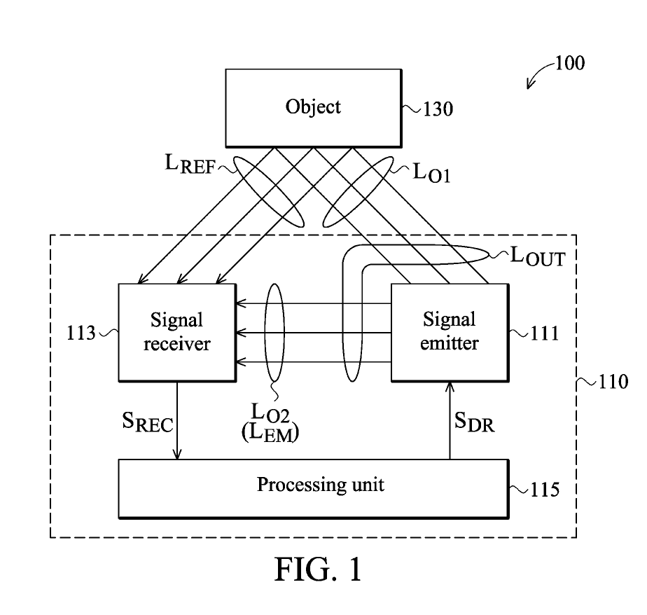

FIG. 1 is a schematic diagram of an exemplary embodiment of an operation system of the invention. The operation system 100 comprises a control device 110 and an object 130. The control device 110 emits an output signal L_{OUT}. In this embodiment, the output signal L_{OUT} is an acoustic wave, such as an ultrasound, but the disclosure is not limited thereto. In other embodiments, the output signal L_{OUT} is a light wave, such as an infrared ray.

The output signal L_{OUT} emitted by the control device 110 comprises output components L_{O1} and L_{O2}. The object 130 reflects the output component L_{O1} to generate a reflected component L_{REF}. The control device 110 obtains the distance between the object 130 and the control 110 according to the result of reflecting the output component L_{O1}. In this embodiment, the control device 110 comprises a signal emitter 111, a signal receiver 113, and a processing unit 115.

The signal emitter 111 emits the output signal L_{OUT}. In this embodiment, the shape of the output signal L_{OUT} is a radiant shape such that the output signal L_{OUT} comprises the output components L_{O1} and L_{O2}. The invention does not limit the kind of signal emitter 111. In one embodiment, the signal emitter 111 is an ultrasound emitter. In other embodiments, the signal emitter 111 is an infrared ray emitter or a light emitting diode (LED).

The signal receiver 113 receives signals, integrates the received signals into an input signal S_{REC}, and transmits the input signal S_{REC} to the processing unit 115. In this embodiment, when the output component L_{O1} is reflected by the object 130, a reflected component L_{REF} is generated. Thus, the input signal S_{REC} comprises a reflected component L_{REF}. When the signal receiver 113 directly receives the output component L_{O2}, the input signal S_{REC} comprises an emitted component L_{EM}.

When the input signal S_{REC} simultaneously comprises the reflected component L_{REF} and the emitted component L_{EM} and the object 130 closely approaches the signal receiver 113, the processing unit 115 utilizes at least two threshold values to compare the amplitude of the input signal S_{REC} to differentiate the reflected component L_{REF} and the emitted component L_{EM} and invalidate the emitted component L_{EM}. In this embodiment, when the distance between the object 130 and the signal receiver 113 is 0.6 cm, the processing unit 115 is capable of differentiating the reflected component L_{REF} and the emitted component L_{EM} from the input signal S_{REC}. In one embodiment, the distance between the signal emitter 111 and the signal receiver 113 is approximately 2.2 cm.

The invention does not limit the number of threshold values. In some embodiments, the number of threshold values is more than 2. Two threshold values are given as an example to describe the differentiating method of the processing unit 115.

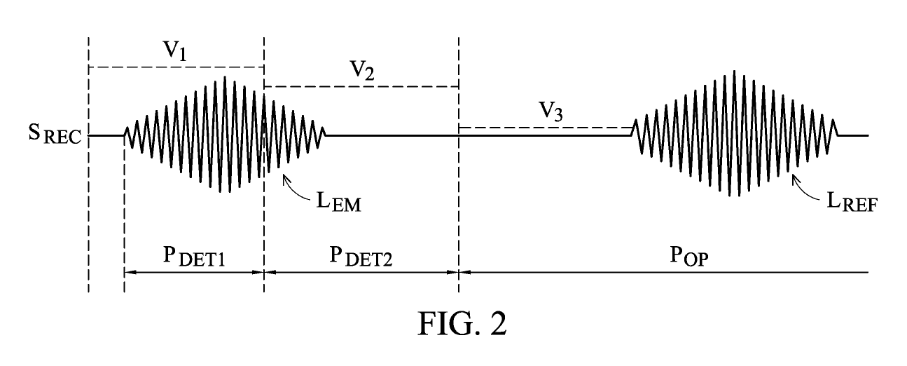

FIG. 2 is a schematic diagram of an exemplary embodiment of the input signal S_{REC}. During the determination period P_{DET1}, the processing unit 115 compares a threshold value V₁ with the amplitude of the input signal S_{REC}. During the determination period P_{DET2}, the processing unit 115 compares a threshold value V₂ with the amplitude of the input signal S_{REC}. The reflected component L_{REF} and the emitted component L_{EM} of the input signal S_{REC} can be differentiated according to the result of the comparison of the threshold value V₁ with the amplitude of the input signal S_{REC} and comparing the threshold value V₂ with the amplitude of the input signal S_{REC}.

Referring to FIG. 2, the amplitude of the input signal S_{REC} is less than the threshold value V₁ during the determination period P_{DET1} and the amplitude of the input signal S_{REC} is less than the threshold value V₂ during the determination period P_{DET2}. Thus, the component of the input signal S_{REC} is the emitted component L_{EM} during the determination periods P_{DET1} and P_{DET2}.

Since the emitted component L_{EM} is the output component L_{O2} directly emitted by the signal emitter 111 and is not a reflected component, the processing unit 115 invalidates the emitted component L_{EM} of the input signal S_{REC}.

During an operation period P_{OP}, the processing unit 115 compares a threshold value V₃ with the amplitude of the input signal S_{REC}. When the amplitude of the input signal S_{REC} is higher than the threshold value V₃, the component of the input signal S_{REC} is the reflected component L_{REF} during the operation period P_{OP}. Since the reflected component L_{REF} is generated by the object 130, the processing unit 115 obtains the distance between the object 130 and the control device 110 according to the amplitude and the occurrence time of the reflected component L_{REF}.

In this embodiment, the threshold values V₁˜V₃ are predetermined. In one embodiment, the threshold value V₁ is higher than the threshold value V₂ and the determination period P_{DET1} is shorter than the determination period P_{DET2}, but the disclosures are not limited thereto. In some embodiments, the determination period P_{DET1} is longer than the determination period P_{DET2}. Furthermore, the threshold value V₃ may be less than the threshold value V₂ and the operation period P_{OP} is longer than the determination period P_{DET2}.

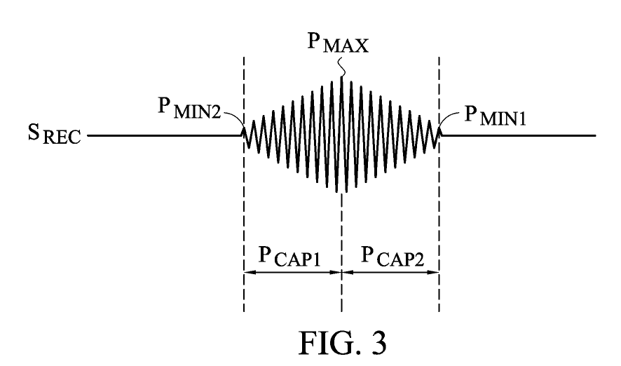

FIG. 3 is a schematic diagram of an exemplary embodiment defining the threshold values V₁˜V₃. Referring to FIG. 1, when the signal emitter 111 emits the output signal L_{OUT}, the signal receiver 113 may first receive the output component L_{O2} and then receive the reflected component L_{REF}. Thus, the processing unit 115 samples the input signal S_{REC} during a capturing period P_{CAP1} and then defines the threshold value V₁ according to the sample results of the input signal S_{REC} during the capturing period P_{CAP1}. In this embodiment, the peak values of the input signal S_{REC} are gradually increased during the capturing period P_{CAP1}.

In one embodiment, the processing unit 115 samples the peak values of the input signal S_{REC} during the capturing period P_{CAP1}. Thus, the threshold value V₁ may be the maximum peak value P_{MAX} of the input signal S_{REC} during the capturing period P_{CAP1}. In other embodiments, the threshold value V₁ is higher than the maximum peak value P_{MAX}.

During a capturing period P_{CAP2}, the processing unit 115 samples the input signal S_{REC}. The processing unit 115 defines the threshold value V₂ according to the result of sampling the input signal S_{REC} during the capturing period P_{CAP2}. In this embodiment, the peak values of the input signal S_{REC} are gradually reduced during the capturing period P_{CAP2}. In one embodiment, the processing unit 115 captures all peak values of the input signal S_{REC} during the capturing period P_{CAP2} and obtains an average value of all peak values of the input signal S_{REC} during the capturing period P_{CAP2}. In one embodiment, the average value can serve as the threshold value V₂. In another embodiment, the threshold value V₂ is higher than the average value.

Additionally, the processing unit 115 defines the threshold value V₃ according to a minimum peak value of the input signal S_{REC}. In one embodiment, the processing unit 115 defines the threshold value V₃ according to the minimum peak value P_{MIN1} of the input signal S_{REC} during the capturing period P_{CAP2}. In another embodiment, the processing unit 115 defines the threshold value V₃ according to a minimum peak value P_{MIN2} of the input signal S_{REC} during the capturing period P_{CAP1}.

When the threshold values V₁˜V₃ are defined, the duration of the periods P_{DET1}, P_{DET2}, and P_{OP} shown in FIG. 2 can be determined. For example, the threshold value V₂ is utilized to determine the end time of the determination period P_{DET1} and the start time of the determination period P_{DET2}.

The processing unit 115 differentiates the reflected component L_{REF} and the emitted component L_{EM} of the input signal S_{REC} according to the threshold values V₁˜V₃. Thus, the processing unit 115 correctly obtains the distance between the object 130 and the control device 110 according to the reflected component L_{REF}.

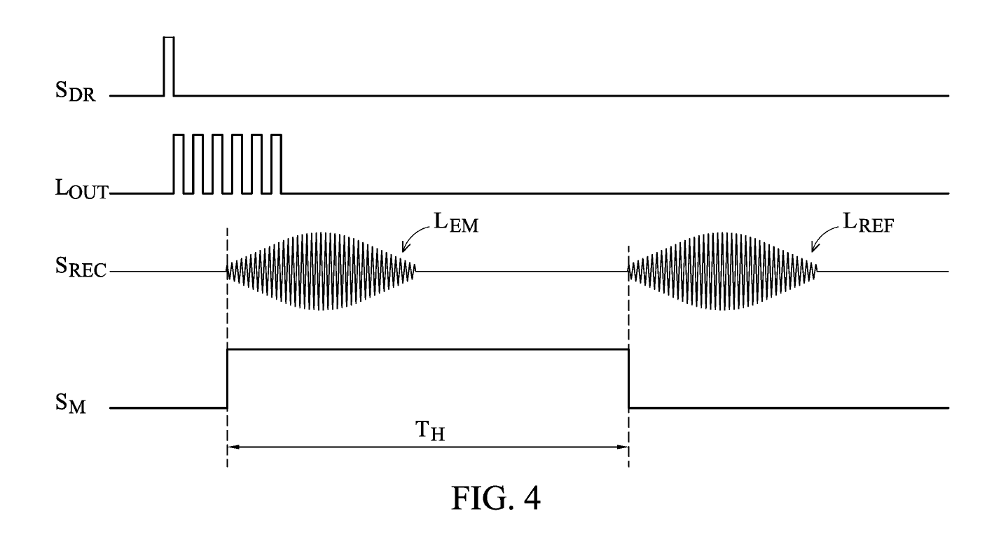

FIG. 4 is a timing diagram of an exemplary embodiment of the invention. Referring to FIG. 1, an external device (not shown) triggers the control device 110 such that the processing unit 115 generates a trigger signal S_{DR}. The signal emitter 111 emits the output signal L_{OUT} according to the trigger signal S_{DR}. The symbol S_{REC} represents an input signal received by the signal receiver 113. The input signal comprises the emitted component L_{EM} and the reflected component L_{REF}.

In this embodiment, when the signal emitter 111 emits the output signal L_{OUT}, a measuring signal S_{M} is changed from a low level to a high level, but the disclosure is not limited thereto. Since the processing unit 115 is capable of differentiating and invalidating the emitted component L_{EM}, when the signal receiver 113 receives the reflected component L_{REF}, the measuring signal S_{M} is changed from the high level to the low level. The processing unit 115 obtains the distance between the object 130 and the control device 110 according to the period T_{H}.

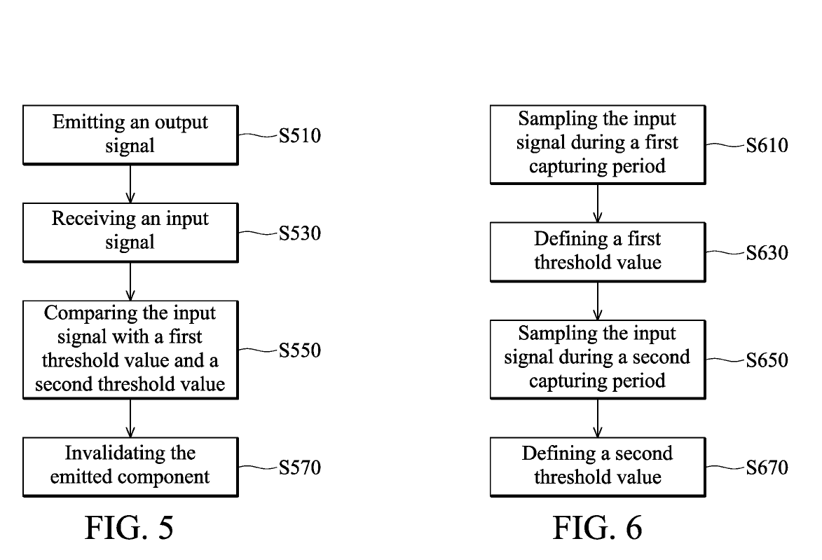

FIG. 5 is a flowchart of an exemplary embodiment of a control method of the invention. First, an output signal is emitted (step S510). In this embodiment, the shape of the output signal is a radiating shape. Thus, a first output component and a second output component can be defined according to the emitting direction of the output signal. Further, the invention does not limit the kind of output signal. In one embodiment, the output signal is an acoustic wave, such as an ultrasound. In another embodiment, the output signal is a light wave, such as an infrared ray.

Then, an input signal is received (step S530). When an object reflects the first output component, the received input signal in the step S530 comprises a reflected component. If the second output component is directly received in the step S530, the received input signal in the step S530 comprises an emitted component.

When the input signal simultaneously comprises the reflected component and the emitted component, a first threshold value and a second threshold value are utilized to differentiate the reflected component and the emitted component (step S550). The invention does not limit the number of the threshold values. In other embodiments, three threshold values and upward are utilized to compare the amplitude of the input signal.

For example, a first threshold value is compared with the amplitude of the input signal during a first determination period and a second threshold value is compared with the amplitude of the input signal during a second determination period. In this embodiment, the first threshold value is higher than the second threshold value. Additionally, the first determination period is shorter than the second determination period.

When the amplitude of the input signal is less than the first threshold value during the first determination period and the amplitude of the input signal is less than the second threshold value during the second determination period, the component of the input signal is the emitted component during the first determination period and the component of the input signal is the emitted component during the second determination period. Thus, the emitted component is invalidated to avoid the emitted component from serving as the reflected component (step S570).

Additionally, a third threshold value is compared with the amplitude of the input signal to obtain the reflected component after the second determination period. In this embodiment, the third threshold value is compared with the amplitude of the input signal during an operation period. When the amplitude of the input signal is higher than the third threshold value, the component of the input signal is a reflected component during the operation period. In one embodiment, the third threshold value is less than the second threshold value and the operation period is longer than the second determination period.

FIG. 6 is a flowchart of an exemplary embodiment defining the first and the second threshold values. During a first capturing period, the input signal is sampled (step S610). In this embodiment, the first capturing period is earlier than the first determination period. After emitting the output signal, the input signal may comprise an emitted component. Thus, the input signal is required to be sampled. Further, the peak values are gradually increased during the first capturing period.

Then, a first threshold value is defined according to the result of sampling the input signal during the first capturing period (step S630). In this embodiment, the input signal comprises a maximum peak value during the first capturing period and the maximum peak value can serve as a first threshold value. In other embodiments, the first threshold value is higher than the maximum peak value of the input signal during the first capturing period.

During a second capturing period, the input signal is sampled (step S650). In this embodiment, the peak values are gradually reduced during the second capturing period.

A second threshold value is defined according to the result of sampling the input signal during the second capturing period (step S670). In one embodiment, the second threshold value is an average value of all peak values of the input signal during the second capturing period.

The input signal comprises a minimum peak value during the first or the second capturing period and the minimum peak value can serve as the third threshold value, but the disclosure is not limited thereto. In some embodiments, the third threshold value is less than the minimum peak value of the input signal.

Taking the operation system 100 as an example, since the processing unit 115 selects the appropriate threshold value to compare the signal received by the signal receiver 113, the reflected component L_{REF} and the emitted component L_{EM} are accurately differentiated and the emitted component L_{EM} is invalidated. When the emitted component L_{EM} is omitted, the processing unit 115 can accurately obtain the distance between the object 130 and the control device 110 according to the reflected component L_{REF}.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A control device, comprising:
a signal emitter emitting an output signal comprising a first output component and a second output component;
a signal receiver receiving an input signal, wherein the input signal comprises a reflected component when the first output component is reflected by an object, and the input signal comprises an emitted component when the second output component is received by the signal receiver; and
a processing unit comparing a first threshold value with the amplitude of the input signal and comparing a second threshold value with the amplitude of the input signal when the input signal simultaneously comprises the reflected component and the emitted component, wherein the processing unit differentiates the reflected component and the emitted component and invalidates the emitted component according to the comparing results.

2. The control device as claimed in claim 1, wherein the output signal is an acoustic wave.

3. The control device as claimed in claim 2, wherein the acoustic wave is an ultrasound.

4. The control device as claimed in claim 1, wherein the output signal is a light wave.

5. The control device as claimed in claim 1, wherein the processing unit compares the first threshold value and the amplitude of the input signal during a first determination period, the processing unit compares the second threshold value and the amplitude of the input signal during a second determination period and the processing unit compares a third threshold value and the amplitude of the input signal during an operation period, the third threshold value is less than the second threshold value, and the operation period is longer than the second determination period; and
wherein when the amplitude of the input signal is less than the first threshold value during the first determination period and the amplitude of the input signal is less than the second threshold value during the second determination period, the component of the input signal is the emitted component during the first determination period and the component of the input signal is the emitted component during the second determination period;
wherein when the amplitude of the input signal is higher than the third threshold value during the operation period, the component of the input signal is the reflected component during the operation period; and
wherein the processing unit obtains the distance between the object and the signal receiver according to the reflected component.

6. The control device as claimed in claim 5, wherein the first threshold value is higher than the second threshold value and the first determination period is shorter than the second determination period.

7. The control device as claimed in claim 5, wherein the processing unit samples the input signal during a first capturing period, and the processing unit defines the first threshold value according to the result of sampling the input signal during the first capturing period.

8. The control device as claimed in claim 7, wherein the input signal comprises a maximum peak value during the first capturing period, and the maximum peak value serves as the first threshold value.

9. The control device as claimed in claim 7, wherein the input signal comprises a maximum peak value during the first capturing period, the first threshold value is higher than the maximum peak value and the peak values of the input signal are gradually increased during the first capturing period.

10. The control device as claimed in claim 7, wherein the processing unit samples the input signal during a second capturing period, and the processing unit defines the second threshold value according to the result of sampling the input signal during the second capturing period.

11. The control device as claimed in claim 12, wherein the second threshold value is an average value of all peak values of the input signal during the second capturing period and the peak values of the input signal are gradually reduced during the second capturing period.

12. A control method, comprising:
emitting an output signal, wherein the output signal comprises a first output component and a second output component;
receiving an input signal, wherein the input signal comprises a reflected component when the first output component is reflected by an object, and the input signal comprises an emitted component when the second output component is directly received; and
when the input signal simultaneously comprises the reflected component and the emitted component, a first threshold value is compared with the input signal and a second threshold value is compared with the input signal to differentiate the reflected component and the emitted component and invalidate the emitted component.

13. The control method as claimed in claim 12, wherein the output signal is an acoustic wave.

14. The control method as claimed in claim 12, wherein the acoustic wave is an ultrasound.

15. The control method as claimed in claim 12, wherein the output signal is a light wave.

16. The control method as claimed in claim 12, further comprising:
comparing the first threshold value and the amplitude of the input signal during a first determination period;
comparing the second threshold value and the amplitude of the input signal during a second determination period; and
comparing a third threshold value and the amplitude of the input signal during an operation period, wherein the third threshold value is less than the second threshold value, and the operation period is longer than the second determination period;
wherein when the amplitude of the input signal is less than the first threshold value during the first determination period and the amplitude of the input signal is less than the second threshold value during the second determination period, the component of the input signal is the emitted component during the first determination period and the component of the input signal is the emitted component during the second determination period; and
wherein when the amplitude of the input signal is higher than the third threshold value during the operation period, the component of the input signal is the reflected component during the operation period.

17. The control method as claimed in claim 16, wherein the first threshold value is higher than the second threshold value and the first determination period is shorter than the second determination period.

18. The control method as claimed in claim 16, wherein further comprising:
sampling the input signal during a first capturing period;
defining the first threshold value according to the result of sampling the input signal during the first capturing period;
sampling the input signal during a second capturing period; and
defining the second threshold value according to the result of sampling the input signal during the second capturing period;
wherein the input signal comprises a maximum peak value during the first capturing period, and the maximum peak value serves as the first threshold value.

19. The control method as claimed in claim 18, wherein the input signal comprises a maximum peak value during the first capturing period, the maximum peak value is less than the first threshold value, and the peak values of the input signal are gradually increased during the first capturing period

20. The control method as claimed in claim 18, wherein the second threshold value is an average value of all peak values of the input signal during the second capturing period and the peak values of the input signal are gradually reduced during the second capturing period.
